(19) United States
(12) Patent Application Publication
(10) Pub. No.: US 2025/0382229 A1
(43) Pub. Date: Dec. 18, 2025

(54) CEMENT FREE SELF-LEVELING MATERIALS

(71) Applicant: Laticrete International, Inc., Bethany, CT (US)

(72) Inventors: Iqbal Khan, Rajasthan (IN); Arjunan PERIASWAMY, Peerancheruvu, Hyderabad (IN)

(21) Appl. No.: 18/876,071

(22) PCT Filed: Jun. 23, 2023
(86) PCT No.: PCT/US2023/026116

§ 371 Date: Dec. 17, 2024

(30) Foreign Application Priority Data
Jun. 23, 2022 (IN) 202241036099

(51) Int. Cl. C04B 28/00; C04B 14/06; C04B 16/06; C04B 22/06; C04B 24/04; C04B 24/20; C04B 24/26; C04B 103/00; C04B 103/10; C04B 103/20; C04B 103/44; C04B 103/50; C04B 111/00; C04B 111/34; C04B 111/62

(52) U.S. Cl. CPC C04B 28/006; C04B 14/06; C04B 16/0633; C04B 22/064; C04B 24/045; C04B 24/20; C04B 24/2623; C04B 2103/0079; C04B 2103/10; C04B 2103/20; C04B 2103/44; C04B 2103/50; C04B 2111/00181; C04B 2111/00637; C04B 2111/34; C04B 2111/62

(57) ABSTRACT

Portland cement-free geopolymer based compositions for building materials, methods of making, and use thereof. The Portland cement-free geopolymer based compositions at least include a first pozzolanic binder material, preferably slag, in an amount from about 10-35 wt. % of the composition, and a second pozzolanic binder material, preferably pulverized fly ash, in an amount greater than 0 wt. % to 30 wt. % of the composition. The compositions further include a first alkali activator in an amount greater than 0 wt. % to 2 wt. %, a second alkali activator in an amount greater than 0 wt. % to 5 wt. %, a filler material comprising medium-fine sand in an amount from 10 wt. % to 60 wt. %; and one or more additional additives, wherein wt. % is based on a total weight of the composition. The first alkali activator may be potassium hydroxide powder, while the second alkali activator may be a sodium-based alkali activator.

### TECHNICAL FIELD

The present invention relates to construction materials and, more particularly, to cement free self-leveling materials for use in construction materials.

### DESCRIPTION OF RELATED ART

Existing dry mix building materials are generally formed using one or more major binder materials including Portland cement, calcium aluminate cement, and/or calcium sulphates. Portland cement is one of the well-known binder materials commonly used in formulating cementitious compositions used in the construction industry. These Portland cement containing compositions have been used to make end-products that join tile, masonry and other types of building materials together, fill joints and voids between materials, form building materials themselves, and the like. For instance, end-products made using Portland cement containing compositions include self-leveling compounds, self-leveling underlayments, screeds (i.e., thinner layer of concrete), tile adhesive, grouts, etc.

Over the years, Portland cement has become a preferred binder material due to its low cost and widespread availability of the ingredients used to make it. However, the production of Portland cement is energy intensive and undesirably emits large amounts of carbon dioxide (CO₂) as well as other pollutants that deleteriously affect the environment. Likewise, the well-known binder materials calcium aluminate cement and calcium sulphates are also energy intensive during their manufacture, with both leaving large carbon footprints on the environment as a result of their processing, manufacturing, and chemistries. As such, prior art has been aimed at reducing use of Portland cement, calcium aluminate cement, and/or calcium sulphates due to their detrimental effects on the environment.

In reducing the carbon footprint of Portland cement, use of geopolymers or pozzolan(s) has been implemented in making cementitious binder compositions whereby a portion of the Portland cement component is replaced with one of these environmentally friendly materials. For instance, compositions have been developed that partially replace the Portland cement with geopolymer alternatives such as, fly ash or slag, both of which are by-products of other industries and would otherwise end up in landfills. Fly ash is a waste by-product of thermoelectric power plants, while slag is a waste by-product of blast furnaces in the ironworks industry (i.e., an industrial byproduct of the steel and iron manufacturing process). In these modified binder compositions, the geopolymer substitutes replace only a portion of the Portland cement so that the composition includes both a geopolymer and Portland cement. The inclusion of Portland cement provides the resultant compositions with hydraulic strength properties. Some of these prior art compositions also include use of calcium aluminate cement and/or calcium sulphates to provide various binder and formulation properties.

With known binder compositions still using an amount of Portland cement in their formulations, as well as calcium aluminate cement and calcium sulphate binder materials, energy use and CO₂ emissions will continue to rise due to the ongoing need for the production of Portland cement. In view of the foregoing, there continues to be a need for new and improved construction compositions that avoid use of binder materials that increase CO₂ emissions, while still maintaining binder strength (i.e., hydraulic strength) and overall durability of end-product(s) made using such compositions (e.g., self-leveling compounds, underlayments, screeds, thin-set adhesives, grouts, and other cementitious construction materials), for which the present invention provides a solution thereto.

### SUMMARY OF THE INVENTION

Bearing in mind the problems and deficiencies of the prior art, it is therefore an object of the present invention to provide geopolymer-based cementitious compositions for use as building materials that are free of Portland cement, calcium aluminate cement, and/or calcium sulphates.

Another object of the present invention is to provide geopolymer-based cementitious building compositions that environmentally friendly and reduce CO₂ emissions.

It is another object of the present invention to provide geopolymer-based cementitious building compositions that are free of Portland cement, calcium aluminate cement, and/or calcium sulphates, and are suitable for use in fabricating end-products including, but not limited to, self-leveling compounds, self-leveling underlayments, self-leveling screeds, thin-set tile adhesives, grouts, and 3-D printable mortars.

Yet another object of the present invention is to provide resultant end-product, such as, self-leveling compounds, self-leveling underlayments, screeds, thin-set tile adhesives, grouts, and/or 3-D printable mortars using the various geopolymer-based cementitious compositions of the invention.

The above and other objects, which will be apparent to those skilled in the art, are achieved in the present invention which is directed to Portland cement-free geopolymer based compositions for building materials that include a first pozzolanic binder material and a second pozzolanic binder material, each present in an amount greater than 0 wt. % to 40 wt. % of the composition. The compositions further include a first alkali activator in solution in an amount greater than 0 wt. % to 10 wt. %, a filler material comprising medium-fine sand present in an amount from 10 wt. % to 60 wt. % of the composition; and one or more additional additives, wherein wt. % is based on a total weight of the composition.

In another aspect the invention is directed to Portland cement-free geopolymer based compositions for building materials that include a first pozzolanic binder material in an amount from about 10-35 wt. % of the composition, and a second pozzolanic binder material in an amount from greater than 0 wt. % to 30 wt. % of the composition. The compositions further include a first alkali activator in an amount greater than 0 wt. % to 2 wt. %, a second alkali activator in an amount greater than 0 wt. % to 5 wt. %, a filler material comprising medium-fine sand in an amount from 10 wt. % to 60 wt. % of the composition; and one or more additional additives, wherein wt. % is based on a total weight of the composition.

In accordance with the invention the first pozzolanic binder material may be bulk slag of granulated ground blast furnace slag (GGBFS), blast furnace slag, slag type 120, ferrous metal slag, or finely ground GGBFS, while the second pozzolanic binder may be pulverized fly ash of class F pulverized fly ash or class C pulverized fly ash. The first alkali activator may be potassium hydroxide powder in an amount greater than 0 wt. % to 1 wt. %, while the second alkali activator may be a sodium-based alkali activator present in an amount greater than 0 wt. % to 10 wt. %, both based on the total weight of the composition.

Still other objects and advantages of the invention will in part be obvious and will in part be apparent from the specification.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1A is a chart showing exemplary self-leveling underlayments (SLUs) in accordance with various embodiments of the invention.

FIG. 1B is continuation from FIG. 1A showing additional exemplary SLUs in accordance with various embodiments of the invention.

FIG. 2 is a graph depicting comparative flow properties of prior art cement-based (i.e., OPC) SLUs as compared to the geopolymer/pozzolanic based SLUs of the invention.

FIG. 3 is a graph depicting comparative compressive strength development of prior art cement-based (i.e., OPC) SLUs as compared to the geopolymer/pozzolanic based SLUs of the invention.

### MODE(S) FOR CARRYING OUT INVENTION

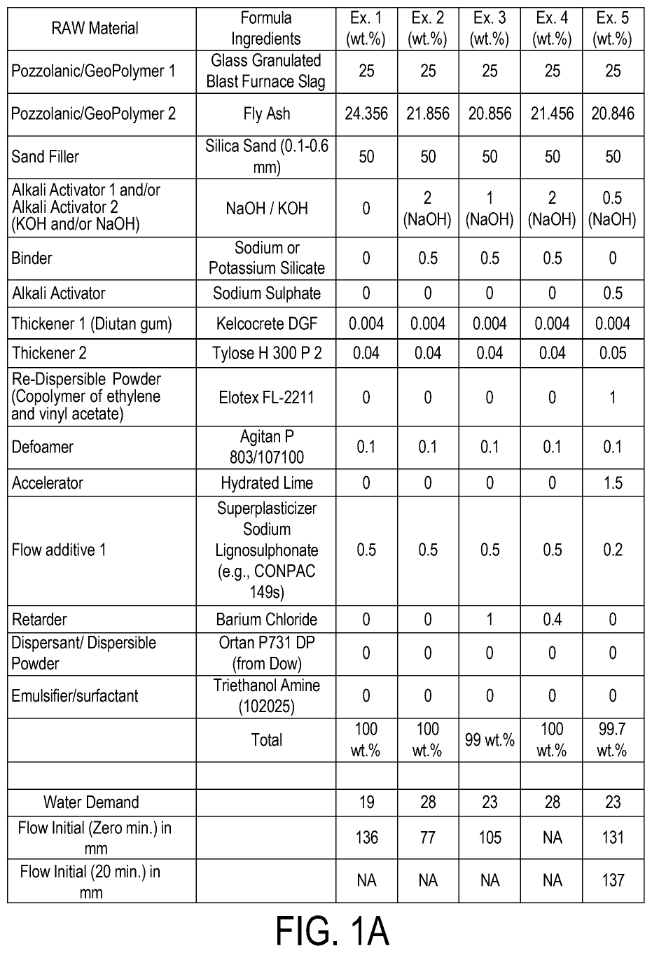

In describing the preferred embodiment of the present invention, reference will be made herein to FIGS. 1A-3 of the drawings in which like numerals refer to like features of the invention.

The embodiments of the present invention can comprise, consist of, and consist essentially of the features and/or steps described herein, as well as any of the additional or optional ingredients, components, steps, or limitations described herein or would otherwise be appreciated by one of skills in the art. It is to be understood that all concentrations disclosed herein are by weight percent (wt. %.) based on a total weight of the composition or formulations being made, unless otherwise indicated.

The various embodiments of the invention provide dry mix, or alternatively ready-to-use, geopolymer-based cementitious compositions for use as building materials that are free of Portland cement, calcium aluminate cement, and/or calcium sulphates. In one or more embodiments, the invention provides cementitious building compositions that avoid the use of Portland cement, calcium aluminate cement, and/or calcium sulphate binders, by providing a slag-based binder system that utilizes a combination of pozzolanic binder materials as the major binder components in combination with one or more alkaline pozzolanic/slag activating or accelerating components. While known binder systems may include a pozzolanic or slag component in combination with an activating or accelerating component, such systems also include use of white Portland cement (WPC) within the formulations. The invention is directed to one or more Portland cement-free binders that avoid the use of at least WPC, as well as avoiding use of calcium aluminate cement and calcium sulphates in such binders and/or compositions, in order to reduce the detrimental effects associated with usage of such materials.

In accordance with the invention, cement free binders are provided that entirely replace a cement component, particularly Portland cement, and more particularly white Portland cement, with two or more pozzolanic component(s), particularly a slag/bulk slag component and a fly ash component, which are activated by one or more alkaline activating components. In doing so, the present cement free binder systems are more environmentally friendly as compared to traditional cementitious binder materials as they utilize the waste by-product slag and fly ash, which would otherwise be disposed of in landfills, and avoid the use of Portland cement thereby reducing CO₂ emission generated by its manufacture. Additional benefits of the present Portland cement free binders are the usability and performance thereof. It has been found that conventional binders that include slag in combination with cement (Portland cement or WPC) in the formulation typically have issues related to setting times and limited early strength development. It has also been found that the caustic alkali activators used in these conventional formulations, such as, caustic bases of silicates of Na₂SiO₂ or sulfates of CaSO₄, cause the binder to set too quickly undesirably decreasing workability time (even though set strength time is increased), or alternatively set too slow providing for sufficient workability time, yet prevent early strength development.

In the present invention, cement free binders are used in formulating various Portland cement-free geopolymer-based cementitious compositions for use as building materials and/or end-products. These building materials/end-products of the invention include, but are not limited to, self-leveling compounds, underlayments, self-leveling underlayments, screeds, self-leveling screeds, thin-set tile adhesives, grouts, and 3-D printable mortars, all of which are surface preparation compositions that prepare a floor/surface area prior to installation of floor cladding, vinyl flooring, ceramic tile, vitrified tile, cement tile, bricks, engineered stones, natural stones, mineral chips, and the like. The present geopolymer-based cementitious compositions and resultant building materials/end-products are all sustainable and environmentally friendly. They also do not include Portland cement, calcium aluminate cement, and/or calcium sulphates, and as such, do not deplete these precious mineral deposits or contribute to CO₂ emissions.

The present formulations of the invention provide Portland cement-free geopolymer based compositions and the resultant end products formed using such compositions. In one or more embodiments the invention is directed to geopolymer based compositions that include a first pozzolanic material in combination with a second pozzolanic material, which are activated by at least first and second alkali activator materials. In certain embodiments, geopolymer based compositions of the invention may also include a metal silicate binder material. In addition to the at least two pozzolanic materials, at least two alkali activator materials, and optional metal silicate binder material, the compositions of the invention may further include a plurality of fillers, and one or more additives or functional additives, all based on a total weight percent of the resultant geopolymer based composition itself.

In more detail, in one or more embodiments the present geopolymer based compositions include a first pozzolanic binder material comprising a bulk slag component (i.e., slag) of granulated ground blast furnace slag (GGBFS), blast furnace slag, slag type 120, ferrous metal slag. For example, the first pozzolanic binder material may be finely ground GGBFS (ground to a fine powder) sold under the tradename NewCem manufactured by Holcim). Preferably the bulk slag component is GGBFS powder present in the composition in amount greater than 0 wt. % to 40 wt. %, based on a total weight of the composition. In certain embodiments, as discussed herein, the first pozzolanic material may be present in an amount ranging from about 10-35 wt. % of the composition, preferably from about 10-25 wt. %, of the composition. The second pozzolanic binder material comprises pulverized fly ash, preferably, class F pulverized fly ash, however, class C pulverized fly ash may also be suitable for use in certain embodiments of the invention. In certain preferred embodiments, the second pozzolanic binder material comprises class F pulverized fly ash present in an amount greater than 0 wt. % to 40 wt. % of the composition, preferably in an amount ranging from about 10-35 wt. %, more preferably from about 15-30 wt. %, of the composition.

The present geopolymer based compositions further include at least two or more alkali activators in combination with the first and second pozzolanic binders. The first alkali activator is potassium hydroxide (KOH) in powder, fine grain, or flake form, preferably KOH powder. The KOH alkali activator is present in the composition in amounts greater than 0 wt. % to 10 wt. %, preferably from greater than 0 wt. % to 2 wt. %, more preferably from greater than 0 wt. % to 1 wt. %, of the composition. The second alkali activator is a sodium-based alkali activator selected from sodium hydroxide (NaOH) powder or sodium sulphate (Na₂SO₄) powder (e.g., crystalline powder). The sodium-based alkali activator may be present in the composition in an amount of greater than 0 wt. % to 10 wt. %, preferably greater than 0 wt. % to 5 wt. %, and more preferably from 0.5 wt. % to 1.5 wt. %, of the composition.

Optionally the geopolymer based compositions of the invention may include a metal silicate, preferably a metal silicate powder, that acts as another binder or binding agent. The metal silicate may include a potassium silicate powder present in the composition in amounts equal to or greater than 0 wt. % to 20 wt. %, preferably from 5 wt. % to 10 wt. %, of the composition.

The various compositions of the invention may also include one or more fillers and/or functional additives to provide different functionalities and attributes to the resultant compositions and end-products. These additives/fillers include one or more types of graded sand including, but not limited to, a medium-fine grade sand filler, a medium-course grade sand filler, and/or a course grade sand filler. The medium-fine grade sand filler may have a grade ranging from 0.2-0.6 MM and may include medium-fine aggregates of quartz, silicon dioxide, natural silica sand, recycled expanded glass beads, perlite light weight minerals (coated and non-coated), light weight hollow cenospheric aggregates, fine light weight aggregates reclaimed from pond ash, and the like. The medium-fine grade sand filler may be present in the composition in amounts ranging from about 10 wt. % to 60 wt. %, preferably from 35 wt. % to 55 wt. %, or in certain embodiment preferably from 15 wt. % to 20 wt. %, all based on the total wt. % of the final composition. The medium-course grade sand filler may have a grade ranging from 0.6-1.2 MM, and may be present in the composition in amounts ranging from about 10 wt. % to 20 wt. %. The course grade sand filler may have a grade ranging from 1.2-2.36 MM, and may be present in the composition in amounts ranging from about 10 wt. % to 20 wt. %.

The compositions of the invention may also include one or more fiber/fibrous components, as well as one or more thickeners/thickening agents, respectively to increase strength and thickness. The fibers may include 3 MM polypropylene fibers (e.g., Recron 3 mm fibers) and/or 6 MM polypropylene fibers (e.g., Recron 6 mm fibers), each present in amounts equal to or greater than 0 wt. % to 0.08 wt. % based on a total weight of the composition. The thickeners may include at least a first thickener and a second thickener. The first thickener may be a plant based thickening additive comprising diutan gum (e.g., Kelocrete DGF manufactured by Kelco GP) present in an amount of equal to or greater than 0 wt. % to 0.008 wt. %, while the second thickener may be a nonionic cellulose ether (e.g., Tylose H 300 P2 or Tylose H 10000 P2DGF manufactured by Shin Et Su) present in an amount of equal to or greater than 0 wt. % to 0.8 wt. %, each based on total weight of the composition.

The compositions of the invention may also include one or more strengthening additives including, for instance, a first strengthening additive of micro silica and/or a second strengthening additive of nano silica. These strengthening additives enhance mechanical and durability properties of the resultant compositions. A suitable micro silica is amorphous silicon dioxide, while a suitable nano silica is hydrophilic fumed silica. The first strengthening additive may be added to the composition in amounts equal to or greater than 0 wt. % to 10 wt. %, while the second strengthening additive may be added to the composition in amounts equal to or greater than 0 wt. % to 3 wt. %, based on a total weight of the composition.

One or more dispersible and/or re-dispersible powders may also be added to the present compositions to improve adhesion and flexibility, as well as provide high final strengths and high cohesive force (cohesion). In one or more embodiments, at least two dispersible/re-dispersible polymer powders are added to the compositions. The first dispersible polymer powder may be a copolymer powder of vinyl acetate and ethylene (e.g., Vinnapas L 5010N or 5044 manufactured by Wacker; Ortan P731 DP manufactured by Dow, etc.) added in amounts equal to or greater than 0 wt. % to 15 wt. %. The second polymer powder may be a vinyl acetate and ethylene copolymer based redispersible binder (e.g., Elotex FL 2211 manufactured by Imerys) added in amounts equal to or greater than 0 wt. % to 3 wt. %, based on a total weight of the composition.

The one or more fillers and/or functional additives may also include defoamers and flow additives. The defoamers may include a blend of liquid hydrocarbons and polyglycols on an inorganic carrier (e.g., Agitan P 803 manufactured by BASF) present in an amount equal to or greater than 0 wt. % to 2 wt. %, based on a total weight of the composition. One or more flow additives may be included in the present compositions. For instance, a first flow additive may be present in an amount equal to or greater than 0 wt. % to 2 wt. % and may include, for instance, naphthalene sulfonate formaldehyde (manufactured by BASF) or a superplasticizer sodium lignosulphonate (e.g., CONPAC 149s (which includes a range of PolyCarboxylate Ether (PCE) polymers)). A second flow additive may be present in the compositions in an amount equal to or greater than 0 wt. % to 1 wt. %, based on a total weight of the composition, and may be sodium trichloro acetate. Shrink reducing agents may also be added to the present compositions. The shrink reducing agent may be a powdered shrinkage reducing additive that includes active components of organic alcohols on an inorganic carrier (e.g., Sitren PSR 100 (SRA 100) manufactured by Evonik). The shrink reducing agent may be present in an amount equal to or greater than 0 wt. % to 3 wt. %, based on a total weight of the composition.

Additional one or more fillers and functional additives include hardeners, retarders, accelerators, and one or more rheology modifiers. The hardener additives may include polyalcohol ester added in an amount equal to or greater than 0 wt. % to 8 wt. %, the retarder may include an organic/inorganic material (e.g. sodium citrate dihydrate manufactured by Dow, barium chloride, or alternatively silicate hardeners of metal alkalis) added in an amount equal to or greater than 0 wt. % to 2 wt. %, and/or an accelerator of hydrated lime added in an amount equal to or greater than 0 wt. % to 3 wt. %, each based on a total weight of the composition. The additives may further include one or more rheology modifiers including micro silica fume (density 0.3 g/cc) present in an amount of greater than 0 wt. % to 4 wt. %, and/or meta-kaolin (density 0.3 g/cc) present in an amount of greater than 0 wt. % to 3 wt. %, both based on a total weight of the composition. The one or more fillers also include water retaining cellulose ether derivatives from wood or cotton pulp present in an amount of greater than 0 wt. % to 0.06 wt. %, based on a total weight of the composition. Other fillers may include emulsifiers or surfactants present in the composition in amounts ranging from greater than 0 wt. % to 3 wt. % (e.g., triethanolamine (e.g., CAS Number102025), based on a total weight of the composition.

In one or more embodiments, the materials discussed herein are mixed in various combinations to render resultant compositions of the invention for use as building materials and/or end-products including self-leveling compounds, underlayments, self-leveling underlayments, screeds, self-leveling screeds, thin-set tile adhesives, grouts, and 3-D printable mortars. In certain embodiments, exemplary self-leveling underlayments (“SLUs”) of the invention may include a first pozzolanic binder material comprising a bulk slag component present in amount greater than 0 wt. % to 40 wt. %, preferably from about 10-35 wt. %, in combination with a second pozzolanic binder material comprising class F pulverized fly ash present in amount greater than 0 wt. % to 40 wt. %, preferably from about 15-30 wt. %, both based on a total weight of the composition. These SLUs of the invention may also include a binder (preferably, potassium silicate powder) present in amount greater than 0 wt. % to 20 wt. %, preferably from about 5-15 wt. %. At least first and second alkali activators are included in the SLUs. The first alkali activator may be KOH powder in an amount greater than 0 wt. % to 10 wt. %, preferably from greater than 0 wt. % to 1 wt. %, while the second alkali activator may be NaOH powder present in an amount greater than 0 wt. % to 10 wt. %, preferably from 0.5 wt. % to 3.5 wt. %, both based on total weight of the composition. Also present in the SLU's of the invention is a metal silicate powder binding agent (such as, potassium silicate powder) present in amounts greater than 0 wt. % to 20 wt. %, preferably from 5 wt. % to 15 wt. %, of the composition.

The SLU's also include fillers comprising medium-fine grade sand filler in amounts ranging from about 10 wt. % to 60 wt. %, preferably from 35 wt. % to 55 wt. %, fibers including 3 MM polypropylene fibers present in an amount greater than 0 wt. % to 0.08 wt. %, one or more thickeners including diutan gum in an amount of greater than 0 wt. % to 0.005 wt. % and a nonionic cellulose ether thickener in an amount of greater than 0 wt. % to 0.8 wt. %, each based on total weight of the composition. Strengthening additives may also be added to the SLU's including, for instance, a first strengthening additive of micro silica in amounts greater than 0 wt. % to 10 wt. %, and nano silica in amounts greater than 0 wt. % to 3 wt. %, based on a total weight of the composition. The SLUs also include a re-dispersible powder, a defoamer, and one or more flow additives. The re-dispersible powder may be a vinyl acetate and ethylene copolymer based redispersible binder added in an amount of greater than 0 wt. % to 2 wt. %, the defoamer may be a blend of liquid hydrocarbons and polyglycols on an inorganic carrier in an amount greater than 0 wt. % to 1 wt. %, both based on a total weight of the composition. The flow additives may include a first flow additive of naphthalene sulfonate formaldehyde in an amount greater than 0.5 wt. % to 1.5 wt. %, and a second flow additive of sodium trichloro acetate present in an amount greater than 0 wt. % to 2 wt. %.

The present SLUs further include a shrink reducing agent in powder form that includes active components of organic alcohols on an inorganic carrier added in an amount greater than 0 wt. % to 2 wt. %. Both hardening agents and retarders may be added to the SLUs. The hardener additive may be polyalcohol ester added in an amount greater than 0 wt. % to 5 wt. %, while the retarder may be an organic/inorganic material added in an amount greater than 0 wt. % to 0.30 wt. %. All of the above weight percent ranges are based on a total weight of the composition.

While not meant to be limiting, below is an exemplary formula of a SLU composition of the invention:

| SLU RAW | | |
|---|---|---|
| COMPONENT | Preferred Material | Wt. % |
| Pozzalanic Binder 1 | GGFS | 12 |
| Pozzalanic Binder 2 | Class F Pulverized Fly Ash | 21.89 |
| Alkali Activator 1 | KOH powder | 0.8 |
| Alkali Activator 2 | NaOH Powder | 0.8 |
| Silicate Binder | potassium silicate powder | 10 |
| Filler | medium-fine aggregate/sand (0.2-0.6 MM) | 44 |
| Fibers | 3 MM polypropylene fibers | 0.008 |
| Thickener 1 | Diutan Gum | 0.002 |
| Strengthener 1 | micro silica | 5 |
| Strengthener 2 | nano silica | 0.5 |
| Re-Dispersible Powder | copolymer of ethylene and vinyl acetate | 1 |
| Defoamer | organic/inorganic material | 0.4 |
| Flow additive 1 | naphthalene sulfonate formaldehyde | 0.8 |
| Flow additive 2 | sodium trichloro acetate | 0.3 |
| Shrink Reducing Agent | organic/inorganic material | 1 |
| Retarder | sodium citrate dihydrate | 1.5 |

| | |
|---|---|
| COMPOSITION TOTAL WEIGHT PERCENTAGE | 100 wt. % |

Referring to FIGS. 1A and 1B, additional exemplary geopolymer/pozzolanic self-leveling underlayments in accordance with various embodiments of the invention were prepared and tested. It was found that various superplasticizers may be implemented as flow additives in the formulations of the invention to enhance and/or affect the alkali media. While not meant to be limiting, some of these superplasticizers include those having polycarboxylate ether (PCE) polymers (e.g., sodium lignosulphonate and triethanolamine (102025), Gujarat PCF 1529, Melflux 5581F, 4411F, Melflux 2651, 4930F, Melflux 6681F, SMF Melment F 10, SNF grade 1 &2 from MYKA, etc.). The majority of the tested PCE based superplasticizers were found to be stable up to 0.5% of NaOH, while melflux 6681F was found to be stable at a dose of 1% NaOH. In addition to the dosage of NaOH, it was also found that the dosage of hydrated lime and sodium sulphate affects the performance of the superplasticizer.

Various dispersible/re-dispersible polymer powders were also tested in the instant formulations. It was found that Ortan P731 DP enhanced flow or flowability. A dose of Ortan P731 DP at 0.05-0.1 wt. % Ortan 731DP, preferably 0.5 wt. % Ortan 731DP, was found to retard setting up to 3 days. It is believed that Ortan 731DP works as a surfactant and reduces the retardation by decoupling the sodium lignosulphonate particles to Ca++ ions. An excess dosage of Ortan 731DP increases the entrapped air and decreases the mortar density. It was also found that dosages of 0.05-0.1 wt. % Ortan 731DP combined with smaller doses of sodium lignosulphonate (e.g., from above 0 up to 0.1-0.2 wt. % sodium lignosulphonate) enhanced the mortar setting time (too much sodium lignosulphonate was found to be detrimental to mortar setting time). Setting times were also enhanced by addition of up to 1 wt. % Triethanol amine (i.e., use of Ortan P731 DP, sodium lignosulphonate, and up to 1 wt. % Triethanol amine).

Referring to the exemplary geopolymer/pozzolanic SLU's in FIGS. 1A and 1B, SLU example 5 having a 4M NaOH alkali activator was found to perform well having a heal time of 40 min, a surface appearance during the heal test to be very smooth (similar to SC500), have a 24-hour compressive strength of 4.03 Mpa, a 7-day compressive strength of 8.6 Mpa, and a 28-day compressive strength of 9.64 Mpa. Additional superplasticizers that are stable at 4M NaOH may also be utilized in example 5 to achieve similar or perhaps even further improved results.

SLU examples 9 and 10 altered the ratio of alkali activator to binder material. It was found that maintaining the alkali activator of sodium sulphate or sodium silicate to a maximum dose of 2 wt. % or under in presence of alkali NaOH in an amount of 1.5-2.5 wt. %, since when larger amounts of Na2SiO3 were added it was found that Na2SiO3 particles remained undissolved resulting in surface erosion. It was also found that adding the alkali NaOH or KOH to the composition as a solution (i.e., an alkali NaOH or KOH solution) was more effective for geopolymerization. It was found that a very high molar ratio of alkali solution (SS/SH 2.0 ratio) added in an amount of 25 wt. % reacts faster and develops maximum strengths of 0.99, 1.24 and 7.09 Mpa respectively at 4 hrs, 8 hrs and 24 hrs. When NaOH 6% was directly added to the composition with 2% of sodium sulphate, maximum strengths of 0.5, 0.8 and 2.56 Mpa were measured at 4 hrs, 8 hrs and 24 hrs, respectively. This confirms geopolymerization initially needs time, and even with less alkali NaOH or KOH solution in an amount of 1.5 wt. %, long term strength may be obtained similar to that of a 3 wt. % dosage of solid alkali NaOH or KOH added directly to the composition. It is preferred that the geopolymer do not contain, or are mixed with, gypsum which affected surface porosity and erosion.

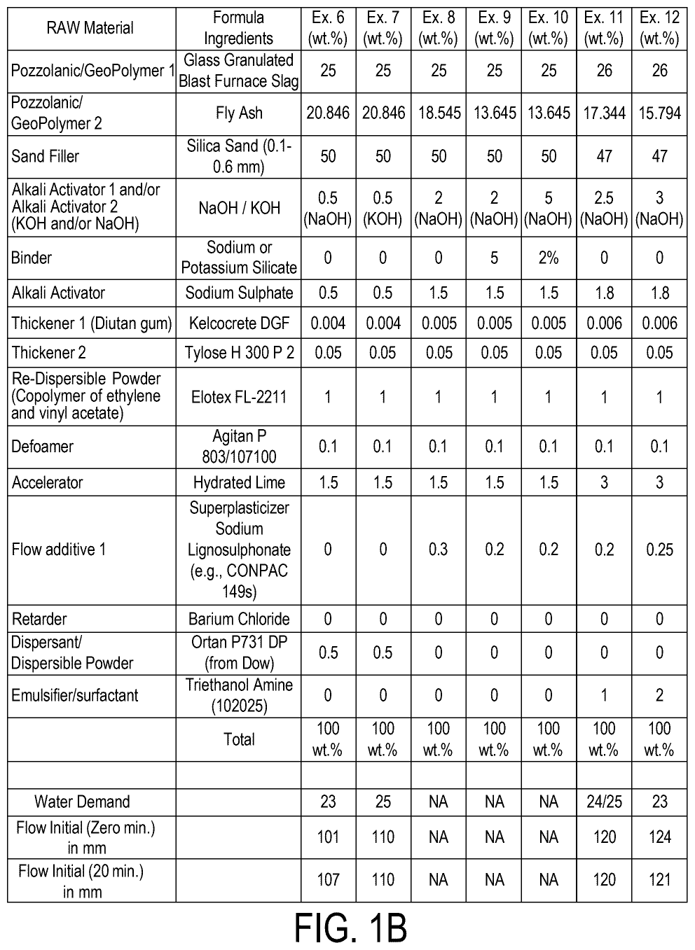

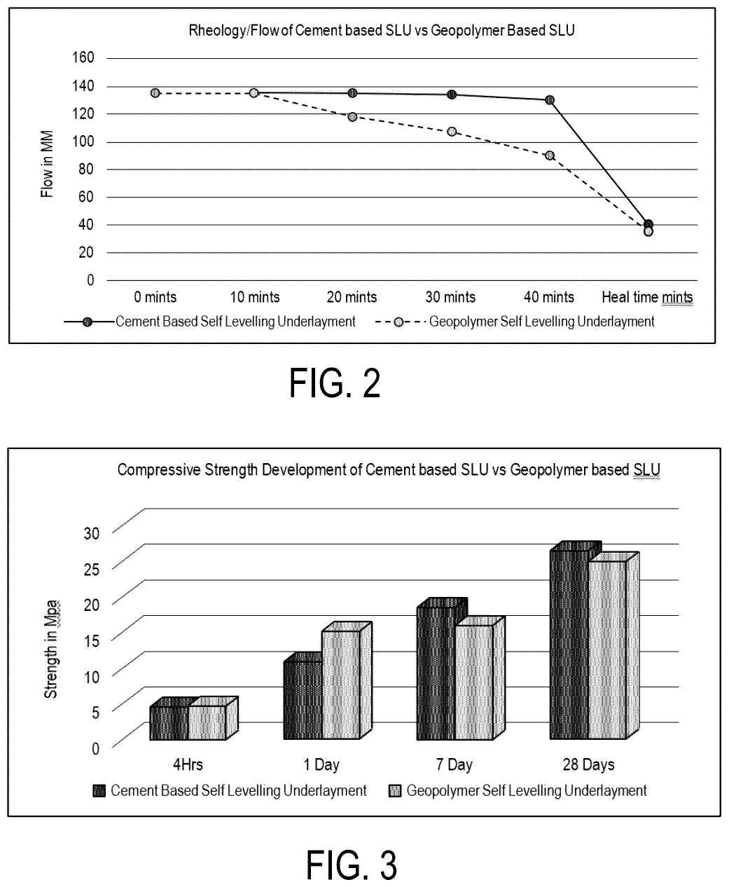

FIGS. 2 and 3 depict, respectively, comparative flow properties and compressive strength development of prior art cement-based (i.e., OPC) SLUs as compared to the present geopolymer/pozzolanic based SLUs. As can be seen, the various SLU formulations of the invention exhibit comparable, if not better, test results as compared to conventional Portland Cement or Ordinary Portland Cement (OPC) based compositions. As such, the present formulations provide environmentally safe alternatives to building material compositions (e/.g. self-leveling compounds, self-leveling underlayments, self-leveling screeds, thin-set tile adhesives, grouts, and 3-D printable mortars) that are economically efficient and decrease greenhouse gases.

Tables 1 and 2 below illustrate test results from the various exemplary formulations depicted in FIGS. 1A and 1B. Both physical and mechanical properties of the geopolymer/pozzolanic SLUs were tested. Table 1 illustrates an overall summary or generalization of the properties of the SLU slurries in their fresh states, which generally exhibited a grey color. The required measures for each parameter, along with their respective measuring units, are described in Table 1, whereby it was found that the group of SLUs of the invention were close to, met or exceeded the test measures thereby exhibiting that the present geopolymer/pozzolanic SLU compositions are an acceptable substitute for convention OPC-based SLUs and other similar materials.

TABLE 1

| | | | | | Present | |
|---|---|---|---|---|---|---|
| | | Standard Test | Specification / | | Geopolymer | |
| Testing Parameter | | Method | Requirement | | Based SLUs | |
| Water:Powder ratio | | * | NA | | 16-22 | mm |
| Application | Initial Flow in | ASTM 1708-11 | 125 | mm | 130-135 | mm |
| | millimeters (mm) | | | | | |
| | Flow retention after 20 | | 125 | mm | 120-130 | mm |
| | Minutes | | | | | |
| | Flow retention after 30 | | 120 | mm | 115-125 | mm |
| | Minutes | | | | | |
| | Flow retention after 40 | | 110 | mm | 105-115 | mm |
| | Minutes | | | | | |
| | Working time /Pot life | ASTM D14, | 20 | mins | 35-40 | mins |
| | @ 25° C. Temp, RH-55% | 1338 | | | | |
| | Self-smoothing open | ASTM1708-11 | 20 | mins | 30-35 | mins |
| | time @ 25° C., RH-55% | | | | | |
| Setting Time | Initial Set Time | EN 13454-2 | ≥50 | mins | 60-80 | mins |
| | Final Set time | | ≤100 | mins | 90-100 | mins |

| | | | | |
|---|---|---|---|---|
| Wet Density of Mix | General | Kg/L | 1.6-2.0 | Kg/L |

| | | | |
|---|---|---|---|
| PH Value of mix | EN 13454-2 | ≥7 | 13-14 |

Table 2 illustrates mechanical property test results of the various exemplary formulations depicted in FIGS. 1A and 1B, whereby it is shown that the present SLUs are comparable, if not better performing than convention OPC-based SLUs and similar materials (e.g., self-leveling compounds, self-leveling screeds, thin-set tile adhesives, etc. and as discussed herein).

TABLE 2

| | | | Standard | | | Present | |
|---|---|---|---|---|---|---|---|
| | | | Test | Specification / | | Geopolymer Based | |
| Testing Parameter | | | Method | Requirement | | SLUs | |
| Bond | 28 | Days | EN 13454-2 | ≥1 | N/MM² | 1.1-1.5 | N/MM² |
| Strength(Mpa) | | | | | | | |
| Flexural | 28 | Days | EN 13892-2 | ≥5 | N/MM² | 4.8-6.0 | N/MM² |
| Strength(Mpa) | | | | | | | |
| Compressive | 4 | Hrs | EN 13892-2 | NA | | 4.0-10 | N/MM² |
| strength in Mpa | 24 | Hrs | EN 13892-2 | NA | | 6.0-15 | N/MM² |
| | 7 | Hrs | EN 13892-2 | NA | | 10.0-20.0 | N/MM² |
| | 28 | Days | | ≥25 | N/MM² | 20.0-30.0 | N/MM² |

| | | | | |
|---|---|---|---|---|
| Surface Finish | After 24 hrs | NA | NA | Smooth |

In other embodiments of the invention, the materials discussed herein are mixed in combinations to provide tile and stone adhesive compositions of the invention. The present adhesives include a first pozzolanic binder material comprising a bulk slag component present in amount greater than 0 wt. % to 40 wt. %, preferably from about 10-35 wt. %, in combination with a second pozzolanic binder material comprising class F pulverized fly ash present in amount greater than 0 wt. % to 40 wt. %, preferably from about 15-30 wt. %, both based on a total weight of the composition. These adhesives may also include a metal silicate binder (preferably, potassium silicate powder) present in amount greater than 0 wt. % to 20 wt. %, preferably from about 5-10 wt. %. A medium-fine grade sand filler is also present in the instant adhesives in amounts ranging from about 10 wt. % to 60 wt. %, preferably from 35 wt. % to 55 wt. %. At least two alkali activators are included in the adhesives. In particular, a first alkali activator may be KOH powder in an amount greater than 0 wt. % to 10 wt. %, preferably from greater than 0 wt. % to 1 wt. %, while the second alkali activator may be NaOH powder present in an amount greater than 0 wt. % to 10 wt. %, preferably from 0.5 wt. % to 1.5 wt. %, both based on total weight of the composition.

The tile and stone adhesive compositions of the invention further include fibers, thickeners, strengtheners, and a dispersible powder. The fibers may include 3 MM polypropylene fibers present in an amount greater than 0 wt. % to 0.05 wt. %, and the thickeners may include a nonionic cellulose ether thickener in an amount of 0.05 wt. % to 0.6 wt. %. The strengthener may include micro silica in amounts greater than 0 wt. % to 2 wt. %, and the dispersible powder may be a copolymer powder of vinyl acetate and ethylene in amounts greater than 0 wt. % to 10 wt. %. The present tile adhesives also include a shrink reducing agent, a hardener and a retarder. The shrink reducing agent may be active components of organic alcohols on an inorganic carrier in an amount greater than 0 wt. % to 0.2 wt. %. The hardener may be polyalcohol ester in an amount greater than 0 wt. % to 5 wt. %, and the retarder may be an organic/inorganic material added in an amount greater than 0 wt. % to 0.30 wt. %, all based on a total weight of the tile and stone adhesive composition.

Embodiments of the invention are also directed to tile grout compositions. The present tile grout compositions include a first pozzolanic binder material comprising a bulk slag component present in amount greater than 0 wt. % to 40 wt. %, preferably from about 10-35 wt. %, in combination with a second pozzolanic binder material comprising class F pulverized fly ash present in amount greater than 0 wt. % to 40 wt. %, preferably from about 15-30 wt. %, both based on a total weight of the composition. These tile grouts may also include a metal silicate binder (preferably, potassium silicate powder) present in amount greater than 0 wt. % to 20 wt. %, preferably from about 5-10 wt. %. At least two alkali activators are included in the tile grouts. In particular, a first alkali activator may be KOH powder in an amount greater than 0 wt. % to 10 wt. % preferably from greater than 0 wt. % to 1 wt. %, while the second alkali activator may be NaOH powder present in an amount greater than 0 wt. % to 10 wt. %, preferably from 0.5 wt. % to 3.5 wt. %, both based on total weight of the composition. A medium-fine grade sand filler (0.2-0.6 MM) is also present in the instant tile grouts in amounts ranging from about 10 wt. % to 60 wt. %, preferably from 35 wt. % to 55 wt. %.

The tile grout adhesive compositions of the invention further include fibers, thickeners, strengtheners, and a redispersible powder. The fibers may include 3 MM polypropylene fibers present in an amount greater than 0 wt. % to 0.05 wt. %, and the thickeners may include a nonionic cellulose ether thickener in an amount of or greater than 0 wt. % to 0.006 wt. %. The strengthener may include micro silica in amounts greater than 0 wt. % to 2 wt. %, and the redispersible powder may be a copolymer powder of vinyl acetate and ethylene in amounts greater than 0 wt. % to 2 wt. %. The present tile adhesives also include a shrink reducing agent, a hardener and a defoamer. The shrink reducing agent may be active components of organic alcohols on an inorganic carrier in an amount greater than 0 wt. % to 0.2 wt. %. The hardener may be polyalcohol ester in an amount greater than 0 wt. % to 5 wt. %, and the defoamer may be a blend of liquid hydrocarbons and polyglycols on an inorganic carrier added in an amount greater than 0 wt. % to 0.05 wt. %, all based on a total weight of the tile grout adhesive composition.

Still other embodiments of the invention are directed to 3-D printing mortar compositions. The present 3-D printing mortar compositions include a first pozzolanic binder material comprising a bulk slag (GGBFS) component present in amount greater than 0 wt. % to 21 wt. %, in combination with a second pozzolanic binder material comprising class F pulverized fly ash present in amount greater than 0 wt. % to 17 wt. %, both based on a total weight of the composition. These 3-D printing mortars may also include at least two alkali activators comprising a first alkali activator of KOH powder in an amount from 0.5 wt. % to 1 wt. %, and a second sodium-based alkali activator of sodium sulphate (Na₂SO₄) crystalline powder present in an amount from 0.5 wt. % to 1 wt. %, both based on total weight of the composition. The 3-D printing mortar compositions further include sand fillers including a medium-fine grade sand filler (0.2-0.6 MM) present in an amount ranging from about 15 wt. % to 20 wt. %, a medium coarse sand filler (0.6-1.2 MM) present in an amount ranging from about 10 wt. % to 20 wt. %, and a coarse sand filler (1.2-2.36 MM) present in an amount ranging from about 10 wt. % to 20 wt. %, based on the total composition weight.

The 3-D printing mortar compositions further include fibers, dispersible powders, rheology modifiers, and an accelerator. The fibers include a first size 3 MM polypropylene fibers present in an amount greater than 0 wt. % to 0.03 wt. % and a second size 6 MM polypropylene fibers present in an amount greater than 0 wt. % to 0.04 wt. %. The dispersible polymer powder may be a copolymer powder of vinyl acetate and ethylene (e.g., Vinnapas L 5010N or 5044 manufactured by Wacker) present in amounts greater than 0 wt. % to 2 wt. %. The rheology modifiers include a first rheology modifier of micro silica fume (density 0.3 g/cc) present in an amount from 1 wt. % to 3 wt. %, in combination with a second rheology modifier of meta-kaolin (density 0.3 g/cc) present in an amount from 1 wt. % to 2 wt. %. The accelerator component may be an accelerator of hydrated lime added present in an amount from 1 wt. % to 2 wt. %, wherein all above weight percentages are based on a total weight of the 3-D printing mortar composition.

In preparing the various compositions of the invention, one or more preferred methods includes first dispersing the polypropylene (PP) fibers within the mixture of the first pozzolanic binder of GGBS and second pozzolanic binder of fly ash. These combined materials of GGBS/fly ash/PP fibers should be mixed well before adding any other ingredients/additives. All of the alkali and silicate powder materials may be mixed together as well, particularly, before adding the alkali and acidic materials together to avoid early reactivity that affects the workability time of the resultant composition. Once all the GGBS/fly ash/PP fibers/alkali/silicate powder materials are mixed together, any acidic materials may then be added to the mixture. For longer shelf life the acids or alkali components may further be coated with a mineral oil for preventing interaction between such materials. This method of mixing is particularly suited for preparing the 3-D printing mortar compositions of the invention. In preparing these mortars, the initial mixture may be thick and hot as the alkalis react first, and as the acids and alkali materials are dissolved into the composition (generally, within one minute) the present mortar becomes loose and workable, as well as cool after about 2-5 minutes. As such, at this stage excess water addition to obtain a desired flow rate should be avoided, as the mixture becomes loose and workable over time and with stirring the wetted composition mixture. The ideal water ratio is 15-16 wt. % based on the amount (weight) of composition being mixed to provide a minimum flow rate of 135 mm flow.

In accordance with the various embodiments of the invention, the various dry-mix compositions of the invention provide final resultant end-product/building material self-leveling compositions when mixed with water, wherein these wetted compositions comprise a uniform flowable slurry. The resultant self-leveling end-product/building material compositions/slurries of each have an adequate working time, levels uniformly, and form a smooth surface ranging from 2 mm to 72 mm thick with dimensional stability.

Once deposited, the compositions/slurries provide a single application surface finish, whereby these surface finishes are dimensionally stable over a large area, are free of minor and/or major cracks, form a hard smooth surface that is able to be walked on within 4 hours after application, develop a minimum of 4 MPa compressive strength within 4 hours of application, develop >30 MPa compressive strength after the final curing, and meet the EN and ASTM standards designed for such product categories. The resultant applied and cured end-products of the invention (formed using the compositions of the invention) are moisture free, smooth preparatory surfaces ready to receive installed cladding including, but not limited to, wood panels, vinyl laminates, ceramic tiles, vitrified tile, cement tile, bricks, engineered stones, natural stones, mineral chips, etc.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. (canceled)

2. A Portland cement-free geopolymer based composition for building materials comprising:
a first pozzolanic binder material present in an amount from about 10-35 wt. % of the composition;
a second pozzolanic binder material present in an amount greater than 0 wt. % to 30 wt. % of the composition;
a first alkali activator present in an amount greater than 0 wt. % to 2 wt. % of the composition;
a second alkali activator present in an amount greater than 0 wt. % to 5 wt. % of the composition;
a filler material comprising medium-fine sand present in an amount from 10 wt. % to 60 wt. % of the composition;
flow aiding agents of naphthalene sulphonated formaldehyde in an amount ranging from 1 wt. % to 2 wt. % and sodium trichoro acetate in an amount ranging from greater than 0 wt. % to 0.5 wt. %; and
one or more additional fillers selected from the group consisting of natural silica sand, recycled expanded glass beads, perlite light weight minerals (coated and non-coated), light weight hollow cenospheric aggregates, and fine light weight aggregates from reclaimed Pond Ash, present in an amount ranging from 40 wt. % to 65 wt. %, based on the total weight of the composition,
wherein wt. % is based on a total weight of the composition

3. The composition of claim 2 wherein the first pozzolanic binder material comprises bulk slag selected from the group consisting of granulated ground blast furnace slag (GGBFS), blast furnace slag, slag type 120, ferrous metal slag, and finely ground GGBFS.

4. The composition of claim 2 wherein the second pozzolanic binder material comprises pulverized fly ash selected from the group consisting of class F pulverized fly ash and class C pulverized fly ash.

5. The composition of claim 2 wherein the first alkali activator is potassium hydroxide powder present in an amount greater than 0 wt. % to 1 wt. %, based on the total weight of the composition, and the second alkali activator is a sodium-based alkali activator present in an amount greater than 0 wt. % to 10 wt. %, based on the total weight of the composition.

6.-8. (canceled)

9. The composition of claim 2 wherein the first alkali activator is potassium hydroxide, and the second alkali activator is a sodium-based alkali activator.

10. The composition of claim 9 wherein the sodium-based alkali activator comprises sodium hydroxide or sodium sulphate.

11. (canceled)

12. The composition of claim 2 further including a metal silicate binder comprising a potassium silicate powder present in an amount from 5 wt. % to 20 wt. %, based on the total weight of the composition.

13.-14. (canceled)

15. The composition of claim 2 wherein the one or more additional additives comprises polypropylene fibers selected from the group consisting of 3 MM polypropylene fibers present in an amount equal to or greater than 0 wt. % to 0.08 wt. %, 6 MM polypropylene fibers present in an amount equal to or greater than 0 wt. % to 0.08 wt. %, or a combination of 3 MM polypropylene fibers and 6 MM polypropylene fibers each present in amounts equal to or greater than 0 wt. % to 0.08 wt. %, each based on the total weight of the composition.

16.-19. (canceled)

20. The composition of claim 2 wherein the one or more additional additives are selected from the group consisting of one or more thickening agents, one or more strengthening agents, one or more dispersible powders, a defoamer, flow additives, shrink reducing agents, hardener, retarder, accelerator, and rheology modifiers.

21. The composition of claim 2 wherein the geopolymer based composition comprises a self-leveling composition selected from the group consisting of a self-leveling underlayment, a self-leveling screed, a self-leveling tile adhesive, a self-leveling grout, and a self-leveling 3-D printable mortar.

22. The composition of claim 2 wherein the geopolymer based composition does not contain Portland cement, calcium aluminate cement, or calcium sulphates.

23. (canceled)

24. A Portland cement-free geopolymer based composition that is a self-leveling underlayment, a tile adhesive or a grout comprising:
a first pozzolanic binder material present in an amount from about 10-35 wt. % of the composition;
a second pozzolanic binder material present in an amount greater than 0 wt. % to 30 wt. % of the composition;
a first alkali activator present in an amount greater than 0 wt. % to 2 wt. % of the composition;
a second alkali activator present in an amount greater than 0 wt. % to 5 wt. % of the composition;
a metal silicate binder comprising a potassium silicate powder present in an amount from 5 wt. % to 10 wt. %,
a filler material comprising medium-fine sand present in an amount from 10 wt. % to 60 wt. %,
3 MM polypropylene fibers present in an amount greater than 0 wt. % to 0.05 wt. %,
one or more thickening agents each present in an amount greater than 0 wt. % to 0.6 wt. %,
one or more strengthening agents each present in an amount greater than 0 wt. % to 10 wt. %,
a dispersible powder present in an amount greater than 0 wt. % to 10 wt. %,
a shrink reducing agent present in an amount greater than 0 wt. % to 2 wt. %,
a hardener present in an amount greater than 0 wt. % to 5 wt. %,
wherein wt. % is based on the total weight of the composition.

25. The composition of claim 24 wherein the geopolymer based composition is the self-leveling underlayment or the grout, and further includes a defoamer present in an amount greater than 0 wt. % to 1.0%, wherein wt. % is based on the total weight of the composition.

26. The composition of claim 24 wherein the geopolymer based composition is the self-leveling underlayment, and further includes one or more flow additives present in an amount greater than 0 wt. % to 1.5%, wherein wt. % is based on the total weight of the composition.

27. The composition of claim 24 wherein the geopolymer based composition is the self-leveling underlayment or the tile adhesive, and further includes a retarder present in an amount greater than 0 wt. % to 0.3 wt. %, wherein wt. % is based on the total weight of the composition.

28. A Portland cement-free geopolymer based composition that is a self-leveling 3-D printable mortar comprising:
a first pozzolanic binder material present in an amount from greater than 0 wt. % to 21 wt. %,
a second pozzolanic binder material present in an amount from greater than 0 wt. % to 17 wt. %,
a first alkali activator comprising KOH powder present in an amount from 0.5 wt. % to 5 wt. %,
a second alkali activator comprising sodium sulphate present in an amount from 0.5 wt. % to 5 wt. %,
said medium-fine sand present in an amount ranging from 15 wt. % to 20 wt. %,
a medium-course grade sand filler present in an amount ranging from 10 wt. % to 20 wt. %,
a course grade sand filler present in an amount ranging from 10 wt. % to 20 wt. %,
3 MM polypropylene fibers present in an amount from greater than 0 wt. % to 0.04 wt. %,
6 MM polypropylene fibers present in an amount from greater than 0 wt. % to 0.03 wt. %,
a dispersible copolymer powder of vinyl acetate and ethylene present in an amount greater than 0 wt. % to 2 wt. %,
an accelerator comprising hydrated lime present in an amount ranging from 1 wt. % to 2 wt. %,
wherein wt. % is based on the total weight of the composition.

29. The composition of claim 2 wherein the geopolymer based composition further includes organic/inorganic accelerators and retarders each in amounts ranging from 1 wt. % to 2 wt. %, based on the total weight of the composition.

30. The composition of claim 2 wherein the geopolymer based composition further includes hardening and accelerating additives of metal alkalis of sodium and potassium each in amounts ranging from 1 wt. % to 2 wt. %, based on the total weight of the composition.

31. The composition of claim 2 wherein the geopolymer based composition further includes silicate hardeners in amounts ranging from 1 wt. % to 2 wt. %, based on the total weight of the composition.

32. The composition of claim 2 wherein the geopolymer based composition further includes poly alcohol ester in an amount greater than 0 wt. % to 0.5 wt. %, based on the total weight of the composition.

33.-38. (canceled)
